(19) United States
(12) Patent Application Publication
(10) Pub. No.: US 2026/0154952 A1
(43) Pub. Date: Jun. 4, 2026

(54) ASYMMETRIC CROSS-MODAL LARGE-MODEL KNOWLEDGE TRANSFER METHOD AND APPARATUS FOR REMOTE SENSING

(71) Applicant: ZHEJIANG LAB, Hangzhou (CN)

(72) Inventors: Chao LI, Hangzhou (CN); Kelu YAO, Hangzhou (CN); Riling WEI, Hangzhou (CN)

(73) Assignee: ZHEJIANG LAB, Hangzhou (CN)

(21) Appl. No.: 19/383,448

(22) Filed: Nov. 7, 2025

(30) Foreign Application Priority Data
Nov. 29, 2024 (CN) 202411742034.8

(51) Int. Cl. G06V 10/778; G06V 10/74; G06V 10/764; G06V 10/774; G06V 20/10

(52) U.S. Cl. CPC G06V 10/7792; G06V 10/761; G06V 10/764; G06V 10/774; G06V 20/10

(57) ABSTRACT

An asymmetric cross-modal large-model knowledge transfer method for remote sensing includes: acquiring a training sample pairs including a sample RGB image and a sample MS image corresponding to a same scene classification; inputting the sample MS image into a teacher model; determining a first image feature extracted by the teacher model from the sample MS image; determining a first scene classification, obtained by the teacher model according to the first image feature, as a pseudo label; inputting the sample RGB image into a student model; determining a second image feature extracted by the student model from the sample RGB image; determining a second scene classification obtained by the student model according to the second image feature; and training the student model according to a difference between the second image feature and the first image feature and a difference between the second scene classification and the pseudo label.

### CROSS-REFERENCE TO RELATED APPLICATIONS

The present disclosure claims priority to the Chinese Patent Application No. 202411742034.8, filed with the Chinese Patent Office on Nov. 29, 2024, which is incorporated herein by reference in its entirety.

### TECHNICAL FIELD

The present disclosure relates to the field of computer technologies, and in particular, to an asymmetric cross-modal large-model knowledge transfer method and apparatus for remote sensing.

### BACKGROUND

Remote sensing image scene classification aims to, for images in different scenes, determine a scene classification corresponding to each image according to the respective semantic information of the image, which plays an important role in the fields of geological exploration, national defense security, etc. Common remote sensing image classification method are usually based on visible light images, and features of RGB images are extracted and classified by designing a deep feature extraction network. In recent years, with the development of large language models, some researchers propose to classify remote sensing images by using a multimodal large language model, but the accuracy of classification results cannot be guaranteed due to fewer spectral bands and lower information density of RGB images.

### SUMMARY

The present disclosure provides an asymmetric cross-modal large-model knowledge transfer method and apparatus for remote sensing, to partially resolve the above-mentioned problems.

The present disclosure adopts the following technical solutions described below.

The present disclosure provides an asymmetric cross-modal large-model knowledge transfer method for remote sensing, including: acquiring a training sample pair including a sample RGB image and a sample MS image, the sample RGB image and the sample MS image corresponding to a same scene classification; inputting the sample MS image into a pre-trained teacher model, determining a first image feature extracted by the teacher model from the sample MS image, and determining a first scene classification, obtained by the teacher model according to the first image feature as a pseudo label; inputting the sample RGB image into a student model, determining a second image feature extracted by the student model from the sample RGB image, and determining a second scene classification obtained by the student model according to the second image feature; and training, according to a difference between the second image feature and the first image feature and a difference between the second scene classification and the pseudo label, the student model.

In some embodiments, the method further includes: determining at least one positive sample pair and a plurality of negative sample pairs as a sample set, inputting the sample set into a to-be-trained matching model, and determining matching determination results for the sample set output by the to-be-trained matching model, where each of the at least one positive sample pair includes an RGB image and an MS image that share strong semantic consistency, and each of the plurality of negative sample pairs includes an RGB image and an MS image that correspond to different scene classifications; training, according to the matching determination results and actual matching situations between respective sample pairs in the sample set, the to-be-trained matching model; acquiring a to-be-matched RGB image set and a to-be-matched MS image set, where for any one RGB image in the to-be-matched RGB image set, the to-be-matched MS image set has an MS image with a same scene classification as the RGB image; for any one RGB image in the to-be-matched RGB image set, in the to-be-matched MS image set, determining an MS image matching the RGB image as a target image by using a trained matching model, and matching the target image and the RGB image as a matched training sample pair; and combining multiple matched training sample pairs into a training sample set, and training the student model.

In some embodiments, the pre-trained teacher model is obtained by: acquiring a pre-training MS image; inputting the pre-training MS image into a to-be-trained teacher model, and determining a third scene classification output by the to-be-trained teacher model; and training the to-be-trained teacher model according to a difference between the third scene classification and a scene label of the pre-training MS image.

In some embodiments, the first image feature and the second image feature have a same data structure.

Training, according to a difference between the second image feature and the first image feature and a difference between the second scene classification and the pseudo label, the student model includes: determining a first feature map corresponding to the first image feature and a second feature map corresponding to the second image feature according to a cross-modal attention; determining a difference between the first image feature and the second image feature according to a domain shift loss between the first feature map and the second feature map; and training according to a difference between the second image feature and the first image feature and a difference between the second scene classification and the pseudo label, the student model.

In some embodiments, training, according to the difference between the second image feature and the first image feature and the difference between the second scene classification and the pseudo label, the student model includes: training, according to the difference between the second image feature and the first image feature, the difference between the second scene classification and the pseudo label, and a difference between the second scene classification and a real scene label corresponding to the sample RGB image, the student model.

In some embodiments, acquiring the training sample pair including the sample RGB image and the sample MS image includes: acquiring the training sample pair including the sample RGB image and the sample MS image from a training sample set, where the training sample set including a plurality of training sample pairs; after training the student model according to the difference between the second image feature and the first image feature and the difference between the second scene classification and the pseudo label, the method further includes: re-acquiring a training sample pair from the training sample set, continuing to train the student model according to the re-acquired training sample pair until that a quantity of training times reaches a training threshold, re-determining a second scene classification corresponding to each sample RGB image in the training sample set by using the student model that has been trained the quantity of training times, updating sample MS images respectively matching each sample RGB image according to each redetermined second scene classification and a first scene classification corresponding to each sample MS image, and continuing to train the student model according to updated training sample pairs.

In some embodiments, updating sample MS images respectively matching each sample RGB image according to each redetermined second scene classification and a first scene classification corresponding to each sample MS image includes: for any one sample RGB image in the training sample set, determining a sample MS image corresponding to a first scene classification with a smallest difference from the second scene classification of the sample RGB image, as a sample MS image matching the sample RGB image.

The present disclosure provides an asymmetric cross-modal large-model knowledge transfer apparatus for remote sensing, including: an acquisition module, configured to: acquire a training sample pair including a sample RGB image and a sample MS image, the sample RGB image and the sample MS image corresponding to a same scene classification; a teacher module, configured to: input the sample MS image into a pre-trained teacher model, determine a first image feature extracted by the teacher model from the sample MS image, and determine a first scene classification, obtained by the teacher model according to the first image feature, as a pseudo label; a student module, configured to: input the sample RGB image into a student model, determine a second image feature extracted by the student model from the sample RGB image, and determine a second scene classification obtained by the student model according to the second image feature; a training module, configured to: train, according to a difference between the second image feature and the first image feature and a difference between the second scene classification and the pseudo label, the student model.

The present disclosure provides a computer-readable storage medium, where the storage medium stores a computer program, and when the computer program is executed by one or more processors, the above asymmetric cross-modal large-model knowledge transfer method for remote sensing is implemented.

The present disclosure provides a device, including a memory, one or more processors, and a computer program stored in the memory and capable of running on the one or more processors, where the one or more processors, when executing the program, implements the above asymmetric cross-modal large-model knowledge transfer method for remote sensing.

At least one of the above technical solutions used in the present disclosure can achieve the beneficial effects described below.

It may be seen from the above method that, the method may reduce the semantic consistency requirements for the training samples while ensuring the training accuracy, and train more RGB samples by using a smaller quantity of MS training samples, thereby improving the performance of the student model.

### BRIEF DESCRIPTION OF DRAWINGS

The accompanying drawings described herein are used to provide a further understanding of the present disclosure and constitute a part of the present disclosure, and the schematic embodiments of the present disclosure and the description thereof are used to explain the present disclosure and do not constitute improper limitations to the present disclosure. In the drawings:

FIG. 1 is a flowchart of an asymmetric cross-modal large-model knowledge transfer method for remote sensing according to the present disclosure;

FIG. 2 is a flowchart for determining a loss caused by a difference between a first image feature and a second image feature according to the present disclosure;

FIG. 3 is a flowchart for updating training sample pairs in an asymmetric cross-modal large-model knowledge transfer method for remote sensing according to the present disclosure;

FIG. 4 is a diagram of an asymmetric cross-modal large-model knowledge transfer apparatus for remote sensing according to the present disclosure; and

FIG. 5 is a diagram of an electronic device corresponding to FIG. 1 according to the present disclosure.

### DETAILED DESCRIPTION

In order to make the purpose, technical solutions and advantages of the present disclosure clearer, the technical solutions of the present specification will be clearly and completely described below with reference to specific embodiments of the present specification and corresponding drawings. Apparently, the described embodiments are merely some rather than all of the embodiments of this disclosure. All other embodiments obtained by a person of ordinary skill in the art based on the embodiments of the present disclosure without creative efforts shall fall within the protection scope of this application.

Some researchers propose to improve information density of input information by using a multi-spectral (MS) image, so as to further improve recognition performance. Although the overall recognition performance of the MS image is significantly improved compared with the RGB image, in practical applications, the classification using the MS image has the problems such as high acquisition cost, large computing memory overhead, and slow inference speed.

In order to solve the above-mentioned problems, some researchers propose to use a cross-modal distillation technology, which enables the teacher model with MS images as inputs to teach the student model with RGB images as inputs in the training phase. In the inference phase, only the student model with the RGB image as the input needs to be used. However, the premise of the implementation of the distillation technology is that the MS image and the RGB image need to have strong semantic consistency, that is, a pair of the MS image and the RGB image is acquired for the same target. Due to the shortage of MS data, it is difficult to acquire sufficient training samples to use the distillation technology for training, which affects the training efficiency of the student model.

Therefore, the present disclosure provides an asymmetric cross-modal large-model knowledge transfer method and apparatus for remote sensing.

The technical solutions provided in the embodiments of this disclosure are described in detail below with reference to the accompanying drawings.

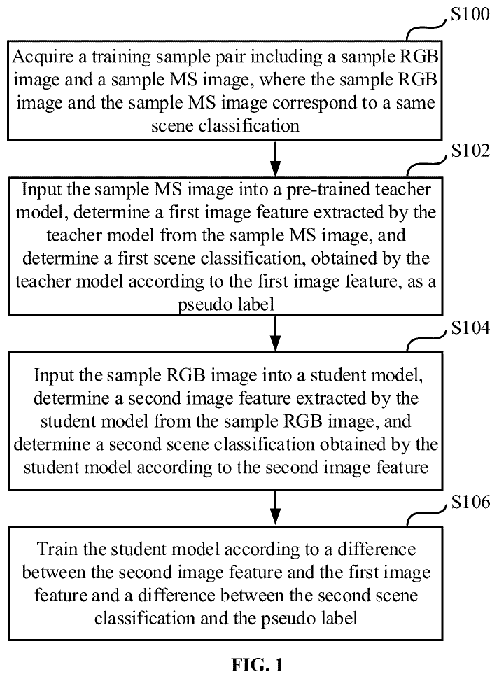

FIG. 1 is a flowchart of an asymmetric cross-modal large-model knowledge transfer method for remote sensing according to the present disclosure, and the asymmetric cross-modal large-model knowledge transfer method for remote sensing includes the steps S100 to S106.

S100: a training sample pair including a sample RGB image and a sample MS image is acquired, where the sample RGB image and the sample MS image correspond to a same scene classification.

Using cross-modal distillation technique to train the student model has strict requirements for the semantic consistency between the data input to the teacher model and the data input to the student model. When the difference between the data input to the teacher model and the data input to the student model is large, for the MS image, spectral bands other than red, green, and blue are removed from the MS image, an RGB image having strong semantic consistency (which may be understood as being acquired from the same target, i.e., the same semantic context) with the MS image may be obtained, but in an actual application process, due to a cost problem of an acquisition device, it is difficult to acquire a large quantity of MS images, and a small quantity of MS training data is difficult to train a student model with wider usage scenarios, therefore, the present disclosure provides an asymmetric cross-modal large-model knowledge transfer method for remote sensing. The execution subject of the present disclosure may be a server used for training a student model or other electronic devices with computing capabilities, which is not limited here in the present disclosure. For ease of description, only a server is used as an execution body, an asymmetric cross-modal large-model knowledge transfer method for remote sensing provided in the present disclosure is described below.

First, a training sample pair including a sample RGB image and a sample MS image is acquired, where one training sample pair includes one sample RGB image and one sample MS image, and the sample RGB image and the sample MS image in one training sample pair are acquired from the same scene classification, but the sample RGB image and the sample MS image in one training sample pair may not have strong semantic consistency, that is, the sample RGB image and the sample MS image in one training sample pair may not be acquired from the same target place.

The scene classification may be a scene classification in the usual sense, including a river, a mountain land, a plain, a city, etc. It may be seen from the above requirements for the training sample pair that, the method provided in the present disclosure has relatively loose requirements for data required for training.

S102: the sample MS image is input into a pre-trained teacher model, a first image feature extracted by the teacher model from the sample MS image is determined, and a first scene classification obtained by the teacher model according to the first image feature is determined as a pseudo label.

After the training sample pair is acquired, the sample MS image may be input to a pre-trained teacher model, where the teacher model includes a feature extraction layer, and the feature extraction layer is used to extract the first image feature from the MS image input to the teacher model.

The above feature extraction layer may use common image feature extraction methods, such as various convolution methods, Scale Invariant Feature Transform (SIFT), Oriented FAST and Rotated BRIEF (ORB), which are not limited here in the present disclosure.

After the first image feature is extracted, other models in the teacher model may continue to process the first image feature, and obtain the first scene classification corresponding to the sample MS image, where the first scene classification may be represented as a probability vector composed of probabilities that the location represented by the sample MS image belongs to respective scene types. Therefore, the student model may learn the processing strategy of the teacher model by using the probability vector.

S104: the sample RGB image is input into a student model, a second image feature extracted by the student model from the sample RGB image is determined, and a second scene classification obtained by the student model according to the second image feature is determined.

On the other hand, after the training sample is acquired, the sample RGB image is input to the student model, where the student model includes a feature extraction layer, and the feature extraction layer is configured to extract a second image feature from the RGB image input to the student model.

It should be noted that, the feature extraction layer of the student model uses the same image feature extraction method as the feature extraction layer of the teacher model, and the second image feature has the same data structure as the first image feature, such that the difference between the first image feature and the second image feature may be determined in the subsequent steps.

S106: the student model is trained according to a difference between the second image feature and the first image feature and a difference between the second scene classification and the pseudo label.

By using a preset loss function, a loss corresponding to the training sample pair is determined according to the difference between the first image feature and the second image feature and the difference between the second scene classification and the pseudo label, and the student model is trained according to a gradient of the loss with respect to each model layer parameter in the student model.

The above loss function may use various common loss functions, such as cross-entropy loss combined with KL divergence, which are not limited here in the present disclosure.

In one or more embodiments of the present disclosure, the loss L_{kd} caused by the difference between the second scene classification and the pseudo label may be determined by using the following formula:

$${ℒ}_{kd} = KL ( {l}_{k}^{t} , {l}_{k}^{s} ; τ ) ,$$

where KL denotes the KL divergence,

$${l}_{k}^{t}$$

denotes the pseudo label,

$${l}_{k}^{s}$$

denotes the second scene classification, and t denotes the distillation temperature.

Thus, by using the difference between the second scene classification and the pseudo label, the student model may learn a specific scene classification strategy of the teacher model for each image, and further, by using the difference between the first image feature and the second image feature, the student model may learn a strategy that the teacher model extracts an important feature related to scene recognition from an image, such that compared with a student model in a conventional knowledge distillation method, the student model in the method provided in this disclosure may more effectively extract an image feature related to the scene classification in the image, which may thereby reduce the semantic consistency requirements for the training samples. The present specification provides a dynamic distillation technique, including two stages: initial matching and dynamic matching. The initial matching is performed prior to student training, where a matcher is trained by using self-supervised and contrastive learning techniques to initially match appropriate teacher samples for each student sample. The dynamic matching is performed throughout the student training phase. Inspired by human educational systems, the most suitable teacher samples are dynamically matched with the student model at different stages for knowledge distillation. Additionally, the present application proposes a plug-and-play semantic-aware knowledge alignment module, which enhances the efficiency of knowledge distillation by optimizing the knowledge transport cost.

In a subsequent actual application process, inputting a target image into the trained student model may determine the scene classification corresponding to the target image.

The asymmetric cross-modal large-model knowledge transfer method for remote sensing as shown in FIG. 1 may reduce the semantic consistency requirements for the training samples while ensuring the training accuracy, and train more RGB samples by using a smaller quantity of MS training samples, thereby improving the performance of the student model.

In addition, before step S100 shown in FIG. 1, the steps further include training a matching model. Training the matching model may include: performing data augmentation based on self-supervised learning, separating RGB images from MS images as positive samples by using self-supervised learning, and then, training the matching model by using MS images and RGB images as inputs by using contrastive learning, where the matching model is configured to match each RGB image with an MS image. The matching model includes an MS encoder and an RGB encoder.

In some embodiments, the MS image contains several spectral bands, among which three bands are the R band, G band, and B band, respectively. For each MS image, the corresponding RGB image can be obtained by extracting R band, G band, and B band from the MS image, and the corresponding RGB image serves as a positive sample. A contrastive learning loss function, InfoNCE loss, is employed to optimize the matching model (e.g., equations (1), (2), and (3) in the specification). Within the same category in a batch, an MS image and its corresponding separated RGB image are treated as a positive sample pair, while RGB images separated from other MS images are treated as negative samples.

Before step S100 shown in FIG. 1, the following steps are performed: determining at least one positive sample pair and a plurality of negative sample pairs as a sample set, inputting the sample set to a to-be-trained matching model, determining matching determination results output by the to-be-trained matching model for the sample set, where the positive sample pair includes one RGB image and one MS image that share strong semantic consistency, for example, the positive sample pair includes an MS image and a corresponding RGB image extracted from the MS image; and the negative sample pair includes one RGB image and one MS image that are correspond to different scene classifications, for example, the negative sample pair includes an MS image and an RGB image that has been extracted from other MS image; training the to-be-trained matching model according to the matching determination results and actual matching situations between respective sample pairs in the sample set; acquiring a to-be-matched RGB image set and a to-be-matched MS image set; for any one RGB image in the to-be-matched RGB image set, the to-be-matched MS image set has an MS image with the same scene classification as the RGB image; for any one RGB image in the to-be-matched RGB image set, in the to-be-matched MS image set, determining an MS image matching the RGB image as a target image by using a trained matching model; and matching the target image and the RGB image as a matched training sample pair. Among them, multiple matched training sample pairs further construct a new training sample set. The training sample set includes MS images and corresponding matched RGB images, and can be used for training the student model. In some embodiments, the student model is trained based on the difference between the second image feature and the first image feature, as well as the difference between the second scene classification and the pseudo-label, and the sample set used in the training is the new training sample set including the multiple matched training sample pairs.

Before training the student model, each training sample pair may also be predetermined, in some embodiments, a to-be-matched RGB image set and a to-be-matched MS image set may be prepared in advance, the to-be-matched RGB image set includes a plurality of to-be-matched RGB images, each to-be-matched RGB image corresponds to a type of scene classifications, the to-be-matched RGB image set includes the to-be-matched RGB images correspond to all types of scene classifications. Similarly, the to-be-matched MS image set includes a plurality of to-be-matched MS images, each to-be-matched MS image corresponds to a type of scene classifications, the to-be-matched MS image set includes the to-be-matched MS images correspond to all types of scene classifications, and subsequently, the to-be-matched RGB image set and the to-be-matched MS image set are matched by using the trained matching model. In some embodiments, for any one to-be-matched RGB image, a pre-matching sample pair may be constructed by the RGB image and all MS images of the to-be-matched MS image set, respectively, then whether each pre-matching sample pair is matched is determined, and according to the matching result, each training sample pair is determined among each pre-matching sample pair. In some embodiments, an MS-RGB image dataset is constructed through collection. The number of categories for MS images and the number of categories for RGB images are the same, but their semantic consistency varies. The collected original unmatched dataset is denoted as:

$$𝒟 = \{ {M}_{k}^{C} , {I}_{N}^{C} \} ,$$

where C denotes the number of categories, K denotes a sample number of MS images per category, N denotes a sample number of RGB images per category, M denotes MS images, and I denotes RGB images.

When the to-be-trained matching model is trained, data of R, G, and B channels in the MS image may be extracted to obtain an RGB image for the same target with strong semantic consistency as the MS image, a pair of an MS image and an RGB image with strong semantic consistency is used as a positive sample pair, and a pair of an MS image and an RGB image corresponding to different scene classifications is used as a negative sample pair; after matching determination results for a sample set output by the to-be-trained matching model are obtained, a loss corresponding to the sample set may be determined according to a preset loss function, and a gradient of the loss with respect to each model layer parameter in the to-be-trained matching model is determined, the to-be-trained matching model is trained, and after a preset training condition is completed, the to-be-trained matching model after trained is used as a matching model used for the matching of training sample pairs. In some embodiments, the training of the matcher includes data augmentation based on self-supervised learning, which involves extracting the sample R channel data, sample G channel data, and sample B channel data from the MS image to construct a strongly semantically aligned dataset

$${𝒟}_{align} = \{ {M}_{k}^{C} , {I}_{K}^{′C} \} ,$$

where I′ denotes the RGB image dataset of M, and the sample number of I′ is consistent with the sample number of M.

In one or more embodiments of the present disclosure, a contrastive learning-based matcher is trained on the organized D_{align} dataset, the matching model may be a matcher based on Contrastive Language-Image Pre-training (CLIP). The matcher contains an MS encoder and an RGB encoder, which encode the MS image

$${M}_{k}^{C}$$

and the RGB image

$${I}_{N}^{C}$$

respectively, to obtain the corresponding MS feature vector v and RGB feature vector s, and then perform training by using the InfoNCE loss function. For the feature vector vₖ in each positive sample pair, the loss function is:

$${ℒ}_{MS \to RGB} = - log \frac{{e}^{{v}_{k} \cdot {s}_{k} / τ}}{{\sum }_{b = 1}^{ℬ} {e}^{{v}_{k} \cdot {s}_{b}}} \qquad ( 1 )$$

$${ℒ}_{RGB \to MS} = - log \frac{{e}^{{s}_{k} \cdot {v}_{k} / τ}}{{\sum }_{b = 1}^{ℬ} {e}^{{s}_{k} \cdot {v}_{b}}} \qquad ( 2 )$$

where [symbol] denotes the quantity of sample pairs in each sample set, and t denotes the distillation temperature.

The total loss function of the matching model is:

$${ℒ}_{CLIP} = \frac{1}{2} ( {ℒ}_{MS \to RGB} + {ℒ}_{RGB \to MS} ) . \qquad ( 3 )$$

Parameters of the trained matcher are saved. Afterward, the matching process is initialized by first loading the parameters of the trained matcher and performing a modality matching task similar to CLIP. For each

$${I}_{N}^{C}$$

in the dataset, the most similar

$${M}_{k}^{′ C}$$

is matched from the category C.

$${M}_{k}^{′ C} and {I}_{N}^{C}$$

are encoded as

$${v}_{k}^{C} and {s}_{N}^{C} ,$$

respectively. In the C^{th} category, the

$${s}_{N}^{C} and N {v}_{k}^{C}$$

highest similarity is found, and the corresponding

$${I}_{N}^{C} and {M}_{k}^{C}$$

are matched by using their

$${s}_{N}^{C} and {v}_{k}^{C}$$

indices. The above steps are repeated until each

$${I}_{N}^{C}$$

in the C^{th} category is matched with a

$${M}_{k}^{′ C} .$$

### After

$${I}_{N}^{C}$$

in al categories are matched with

$${M}_{k}^{′ C} ,$$

a new dataset

$${𝒟}_{match} = \{ {M}_{N}^{′ C} , {I}_{N}^{C} \}$$

is constructed. In addition, before step S100 shown in FIG. 1, a pre-training MS image is acquired, the pre-training MS image is input to a to-be-trained teacher model, the third scene classification output by the to-be-trained teacher model is determined, and the to-be-trained teacher model is trained according to a difference between the third scene classification and a scene label of the pre-training MS image.

Thus, the trained teacher model may accurately recognize the scene classification of the scenes captured by each MS image.

In addition, in step S104 shown in FIG. 1, the first feature map corresponding to the first image feature and a second feature map corresponding to the second image feature are determined according to a cross-modal attention, the difference between the first image feature and the second image feature is determined according to a domain shift loss between the first feature map and the second feature map, and the student model is trained according to the difference between the second image feature and the first image feature and the difference between the second scene classification and the pseudo label.

During the student model training process, the steps include: loading the dataset [symbol] _{match}; loading the teacher model and setting the teacher model to evaluation mode; performing forward propagation by feeding the MS images into the teacher model and feeding RGB images into the student model, where the feature vector

$${e}_{N}^{t}$$

is obtained through a feature extractor of the teacher model, and the feature vector

$${e}_{N}^{s}$$

is obtained through a feature extractor of the student model, the classification vector

$${l}_{N}^{t}$$

is output by a classifier of the teacher model, and the classification vector

$${l}_{N}^{s}$$

is output by a classifier of the student model; designing a semantic-aware knowledge alignment module based on cross-modal attention to calculate a domain shift loss function; calculating a distillation loss function; calculating the total loss function; and performing backpropagation to update parameters of the student model.

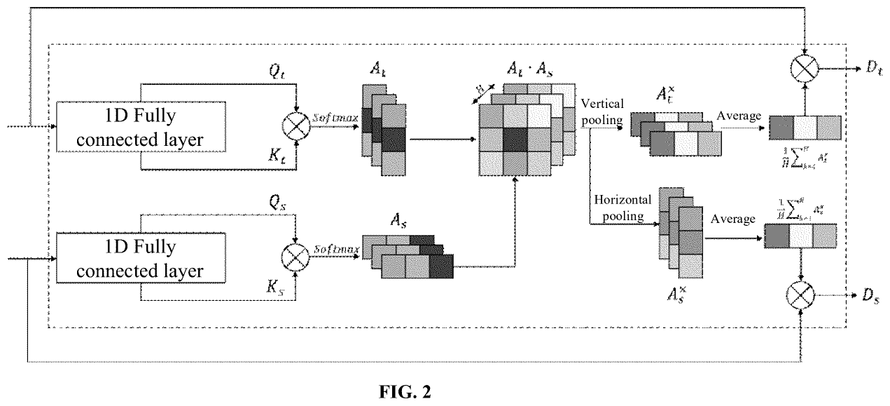

In some embodiments, the design of the semantic-aware knowledge alignment module includes the following: according to the flowchart shown in FIG. 2, determining the loss [symbol] _{da} caused by the difference between the first image feature and the second image feature.

First, an attention map Aₜ of the first image feature and an attention map Aₛ of the second image feature are determined as follows:

$$A = softmax ( Q \cdot \frac{{K}^{T}}{\sqrt{d}} ) , \qquad ( 4 )$$

where d denotes the dimensionality of the feature vector of the image feature; Q and K represent the query word and the key, respectively.

Then,

$${A}_{t}^{\times } and {A}_{s}^{\times }$$

are determined:

$${A}_{t}^{\times } = Mean Pool ( {A}_{t} \cdot {A}_{s}^{T} ) / {scale}_{t} , \qquad ( 5 )$$

$${A}_{s}^{\times } = Mean Pool ( {A}_{s} \cdot {A}_{t}^{T} ) / {scale}_{s} , \qquad ( 6 )$$

where

$${scale}_{t} = \frac{1}{{N}_{t}} {\sum }_{i = 1}^{{N}_{t}} {A}_{t} , {scale}_{s} = \frac{1}{{N}_{s}} {\sum }_{i = 1}^{{N}_{s}} {A}_{s} .$$

Nₜ is equal to Nₛ, Nₜ denotes the quantity of blocks for partitioning the MS image input to the teacher model, and Nₛ denotes the quantity of blocks for partitioning the RGB image input to the student model.

Further, the feature maps Dₜ and Dₛ based on the cross-modal attention are calculated:

$${D}_{t} = {e}_{k}^{t} \cdot \frac{1}{H} {\sum }_{h = 1}^{H} {A}_{t}^{\times } , \qquad ( 7 )$$

$${D}_{s} = {e}_{k}^{s} \cdot \frac{1}{H} {\sum }_{h = 1}^{H} {A}_{s}^{\times } , \qquad ( 8 )$$

where H denotes the quantity of heads of the attention mechanism, which is set to 8 in the embodiment. In some embodiments, the semantic-aware knowledge alignment module is designed by utilizing a multi-head attention mechanism. The teacher features and the student features (i.e., the feature vectors obtained from their respective feature extractors), are extracted by independent fully connected layers, respectively. Subsequently, the respective attention maps are obtained after applying the softmax operation. The cross-modal attention map is then derived by performing element-wise multiplication of these two attention maps. The specific calculation steps are detailed in equations (4) to (8).

Finally, a domain shift loss function, that is, the loss [symbol] _{da} caused by a difference between the first image feature and the second image feature, is calculated:

$${ℒ}_{da} = \frac{1}{d} {‖ {C}_{s} - {C}_{t} ‖}_{F}^{2} , \qquad ( 9 )$$

where Cₛ and Cₜ are obtained by the following formula:

$${C}_{s} = \frac{1}{ℬ - 1} ( {D}_{s}^{T} \cdot {D}_{s} - \frac{1}{ℬ} {( {1}^{T} {D}_{s} )}^{T} ( {1}^{T} {D}_{s} ) ) , \qquad ( 10 )$$

$${C}_{t} = \frac{1}{ℬ - 1} ( {D}_{t}^{T} \cdot {D}_{t} - \frac{1}{ℬ} {( {1}^{T} {D}_{t} )}^{T} ( {1}^{T} {D}_{t} ) ) . \qquad ( 11 )$$

Guiding the training of the student model by using the difference between the first image feature and the second image feature may enable the student model to learn a strategy of extracting the image feature from the teacher model, such that the second image feature extracted by the student model includes more related information of the scene classification, and further, the second scene classification obtained by the student model by using the second image feature is more accurate, which reduces the semantic consistency requirements for the training samples in the training process.

On the other hand, in step S104 shown in FIG. 1, the student model is trained according to the difference between the second image feature and the first image feature, the difference between the second scene classification and the pseudo label, and the difference between the second scene classification and a real scene label corresponding to the sample RGB image.

The loss [symbol] _{kd} indicating the difference between the second scene classification and the pseudo label can be formulated as:

$${ℒ}_{kd} = KL ( {l}_{k}^{t} , {l}_{k}^{s} ; τ ) , \qquad ( 12 )$$

where, KL denotes the KL divergence,

$${l}_{k}^{t}$$

denotes the pseudo label,

$${l}_{k}^{s}$$

denotes the second scene classification, and t denotes the distillation temperature.

The total loss of the student model is set as L:

$$ℒ = {ℒ}_{task} + {ℒ}_{kd} + {ℒ}_{da} , \qquad ( 13 )$$

where [symbol] ₜₐₛₖ denotes the loss caused by the difference between the second scene classification and the real scene label that corresponds to the sample RGB image, and [symbol] _{kd} and [symbol] _{da} has been completely described above, which will not be repeated here. After this, backpropagation is performed to update parameters of the student model. The matched dataset is utilized for the training of the student model. Specifically, MS images are input into the trained teacher model, and the corresponding RGB images are input into the student model. In the semantic-aware knowledge alignment module, the feature vectors output by the teacher model feature extractor and student model feature extractor are used to compute a cross-modal attention. Additionally, a domain loss function is used to address the issue of low knowledge transfer efficiency caused by the increased optimal transport cost due to weak semantic consistency during the training phase.

Thus, the accuracy of the second scene classification obtained by the trained student model may be further increased, thereby reducing the semantic consistency requirements for the training samples in the training process.

Unlike this, in step S100 shown in FIG. 1, a training sample pair including a sample RGB image and a sample MS image is acquired from a training sample set, and the training sample set includes a plurality of training sample pairs; after step S106 shown in FIG. 1, a training sample pair is re-acquired from the training sample set, the student model is continued to be trained according to the re-acquired training sample pair until that the quantity of training times reaches a training threshold, a second scene classification corresponding to each sample RGB image in the training sample set is re-determined by using the student model that has been trained the quantity of training times, sample MS images respectively matching each sample RGB image are updated according to each redetermined second scene classification and a first scene classification that corresponds to each sample MS image, and the student model is continued to be trained according to updated training sample pairs. During the training process, the RGB encoder of the matcher is updated by the current student model. Then, the updated matcher is utilized to construct a new matched dataset by selecting teacher samples for the current student samples. The new matched dataset is loaded and used for student model training until the specified training termination condition is met and the training ends. In some embodiments, during the training process, for every P iterations, dynamically matching the student-teacher sample pairs in

$${𝒟}_{match} = \{ {M}_{N}^{′ C} , {I}_{N}^{C} \}$$

to construct the new matched dataset, including: using the current student model to update the RGB encoder of the matcher; calculating the KL divergence between each I_{N} in the C^{th} category and all M_{N} of the C^{th} category, and obtaining the M_{N} corresponding to the smallest KL divergence as the new teacher sample for IN, thereby updating [symbol] _{match}.

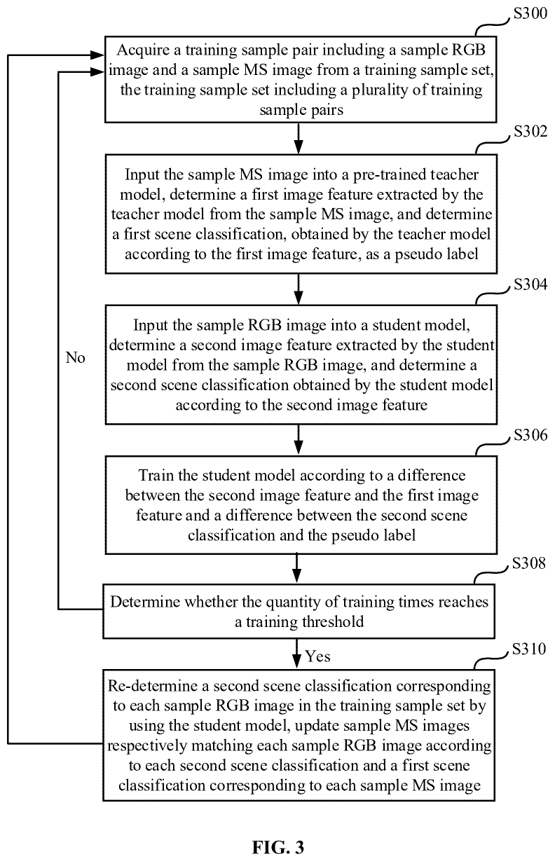

In the training process, as shown in FIG. 3, firstly, step S300 is performed: acquiring a training sample pair including a sample RGB image and a sample MS image from a training sample set, the training sample set including a plurality of training sample pairs.

Subsequently, step S302 is performed: inputting the sample MS image into a pre-trained teacher model, determining a first image feature extracted by the teacher model from the sample MS image, and determining a first scene classification, obtained by the teacher model according to the first image feature, as a pseudo label.

Next, step S304 is performed: inputting the sample RGB image into a student model, determining a second image feature extracted by the student model from the sample RGB image, and determining a second scene classification obtained by the student model according to the second image feature.

Further, step S306 is performed: training the student model according to a difference between the second image feature and the first image feature and a difference between the second scene classification and the pseudo label.

Subsequently, step S308 is performed: determining whether the quantity of training times reaches a training threshold; if not, re-performing steps S300 to S308; otherwise, performing step S310: re-determining a second scene classification corresponding to each sample RGB image in the training sample set by using the student model, updating sample MS images respectively matching each sample RGB image according to each redetermined second scene classification and a first scene classification corresponding to each sample MS image; and resetting the count of the training times with a training threshold, and re-performing steps S300 to S308 until the training is completed.

The completion of training may be set as that the total quantity of training times reaches a preset number, or the loss value calculated by the student model is lower than a preset loss threshold.

Therefore, the scene classification of each sample RGB image in the training sample set may be re-determined by the student model after a certain quantity of training times, and with the improvement of the accuracy of the scene classification of the student model in the training process, the scene classification of the sample RGB image is more accurate, increasing the amount of information that the student model may learn from the training sample pair in each training process.

In some embodiments, in step S308 shown in FIG. 3: for any one sample RGB image in the training sample set, determining a sample MS image corresponding to a first scene classification with a smallest difference from the second scene classification of the sample RGB image, as a sample MS image matching the sample RGB image.

In some embodiments, by calculating the KL divergence between the second scene classification and each first scene classification, a sample MS image corresponding to a first scene classification with a smallest difference from the second scene classification of the sample RGB image is determined.

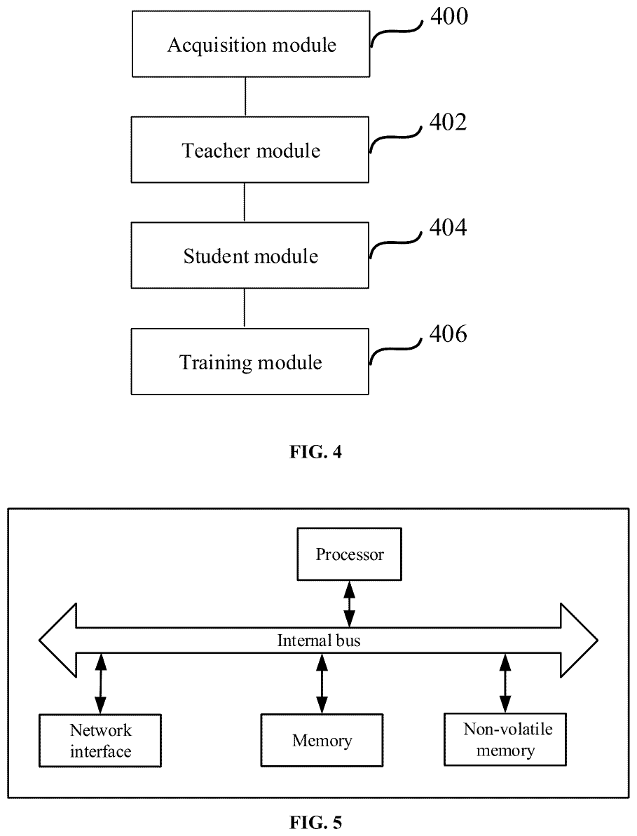

The above is an asymmetric cross-modal large-model knowledge transfer method for remote sensing provided by one or more embodiments of the present disclosure. Based on the same idea, the present disclosure further provides a corresponding asymmetric cross-modal large-model knowledge transfer apparatus for remote sensing, as shown in FIG. 4.

FIG. 4 is a diagram of an asymmetric cross-modal large-model knowledge transfer apparatus for remote sensing provided in the present disclosure, the apparatus includes:
an acquisition module 400, configured to: acquire a training sample pair including a sample RGB image and a sample MS image, the sample RGB image and the sample MS image corresponding to the same scene classification;
a teacher module 402, configured to: input the sample MS image into a pre-trained teacher model, determine a first image feature extracted by the teacher model from the sample MS image, and determine a first scene classification, obtained by the teacher model according to the first image feature, as a pseudo label;
a student module 404, configured to: input the sample RGB image into a student model, determine a second image feature extracted by the student model from the sample RGB image, and determine a second scene classification obtained by the student model according to the second image feature; and
a training module 406, configured to: train the student model according to a difference between the second image feature and the first image feature and a difference between the second scene classification and the pseudo label.

In some embodiments, the acquisition module 400 is further configured to: determine at least one positive sample pair and a plurality of negative sample pairs as a sample set, input the sample set to a to-be-trained matching model, determine matching determination results output by the to-be-trained matching model for the sample set, where each of the at least one positive sample pair includes one RGB image and one MS image that share strong semantic consistency, and each of the plurality of negative sample pairs includes one RGB image and one MS image that are correspond to different scene classifications; train the to-be-trained matching model according to the matching determination results and actual matching situations between respective sample pairs in the sample set, acquire a to-be-matched RGB image set and a to-be-matched MS image set; for any one RGB image in the to-be-matched RGB image set, the to-be-matched MS image set has an MS image with the same scene classification as the RGB image; for any one RGB image in the to-be-matched RGB image set, in the to-be-matched MS image set, determine an MS image matching the RGB image as a target image by using a trained matching model; and match the target image and the RGB image as a matched training sample pair; and combine multiple matched training sample pairs into a training sample set, and train the student model.

In some embodiments, the teacher module 402 is further configured to: acquire a pre-training MS image, input the pre-training MS image into a to-be-trained teacher model, determine the third scene classification output by the to-be-trained teacher model, and train the to-be-trained teacher model according to the difference between the third scene classification and a scene label of the pre-training MS image.

In some embodiments, the first image feature and the second image feature have a same data structure.

The training module 406 is configured to: determine a first feature map corresponding to the first image feature and a second feature map corresponding to the second image feature according to a cross-modal attention, determine a difference between the first image feature and the second image feature according to a domain shift loss between the first feature map and the second feature map, and train the student model according to the difference between the second image feature and the first image feature and the difference between the second scene classification and the pseudo label.

In some embodiments, the training module 406 is configured to: train the student model according to the difference between the second image feature and the first image feature, the difference between the second scene classification and the pseudo label, and the difference between the second scene classification and the real scene label corresponding to the sample RGB image.

In some embodiments, the acquisition module 400 is configured to: acquire a training sample pair including a sample RGB image and a sample MS image from a training sample set, where the training sample set includes a plurality of training sample pairs;

the training module 406 is further configured to: re-acquire a training sample pair from the training sample set, continue to train the student model according to the re-acquired training sample pair until that a quantity of training times reaches a training threshold, re-determine a second scene classification corresponding to each sample RGB image in the training sample set by using the student model that has been trained the quantity of training times, update sample MS images respectively matching each sample RGB image according to each redetermined second scene classification and a first scene classification corresponding to each sample MS image, and continue to train the student model according to updated training sample pairs.

In some embodiments, the training module 406, is configured to: for any one sample RGB image in the training sample set, determine a sample MS image corresponding to a first scene classification with a smallest difference from the second scene classification of the sample RGB image, as a sample MS image matching the sample RGB image.

The present disclosure further provides a computer-readable storage medium, where the storage medium stores a computer program, and the computer program may be used to execute the above asymmetric cross-modal large-model knowledge transfer method for remote sensing provided by FIG. 1.

The present disclosure further provides a structure diagram of the electronic device shown in FIG. 5. As shown in FIG. 5, at the hardware level, the asymmetric cross-modal large-model knowledge transfer device for remote sensing includes a processor, an internal bus, a network interface, a memory, and a non-transitory memory, and certainly may further include hardware required by other services. The processor reads a corresponding computer program from the non-transitory memory into the memory and then runs the computer program, to implement the asymmetric cross-modal large-model knowledge transfer method for remote sensing described in FIG. 1. Certainly, in addition to software implementations, the present disclosure does not exclude other implementations, for example, a logic device or a combination of software and hardware, that is, an execution body of the following processing procedure is not limited to each logic unit, and may also be hardware or a logic device.

In the 1990s, whether a technical improvement is a hardware improvement (for example, an improvement to a circuit structure such as a diode, a transistor, or a switch) or a software improvement (an improvement to a method procedure) may be clearly distinguished. However, with the development of technologies, current improvements to many method procedures can be considered as direct improvements to hardware circuit structures. A designer almost obtains a corresponding hardware circuit structure by programming an improved method procedure into a hardware circuit. Therefore, it cannot be said that an improvement in a method process cannot be implemented by using hardware entity modules. For example, a programmable logic device (PLD) (for example, a field programmable gate array (FPGA)) is such an integrated circuit, and a logic function of the PLD is determined by a user programming the device. Designers are programmed to “integrate” a digital system on a PLD without having to ask chip manufacturers to design and fabricate specialized integrated circuit chips. Moreover, nowadays, instead of manually making integrated circuit chips, this type of programming is mostly implemented by “logic compiler” software, which is similar to a software compiler used during program development and writing, and the original code to be compiled is also written by a specific programming language, which is referred to as a hardware description language (HDL), and there is not only one type of HDL, but many, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc., and a very high-speed integrated circuit hardware description language (VHDL) and Verilog are currently most commonly used. It should also be clear to those skilled in the art that the hardware circuit for implementing the logic method flow can be easily obtained by only programming the method process in the above several hardware description languages for logic programming and programming into the integrated circuit.

The controller may be implemented in any suitable manner, for example, the controller may take the form of, for example, a microprocessor or processor, and a computer-readable medium storing computer-readable program code (for example, software or firmware) executable by the (micro) processor, logic gates, switches, an application specific integrated circuit (ASIC), a programmable logic controller, and an embedded microcontroller, examples of which include but are not limited to the following microcontrollers: ARC 625D, Atmel AT91SAM, Microchip PIC18F26K20, and Silicone Labs C8051F320, and the memory controller may also be implemented as part of the control logic of the memory. Those skilled in the art also knows that, in addition to implementing the controller in the form of purely computer readable program code, it is entirely possible to cause the controller to implement the same functions in the form of logic gates, switches, application specific integrated circuits, programmable logic controllers, embedded microcontrollers, etc., by logically programming the method steps. Therefore, the controller may be considered as a hardware component, and apparatuses included in the controller and configured to implement various functions may also be considered as structures in the hardware component. Alternatively, apparatuses configured to implement various functions may even be considered as both software modules implementing the method and structures in the hardware component.

The system, apparatus, module, or unit illustrated in the above implementations may specifically be implemented by a computer chip or an entity, or may be implemented by a product having a certain function. A typical implementation device is a computer. Specifically, the computer may be, for example, a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the foregoing apparatus is described separately by dividing functions into various units. Certainly, when the present disclosure is implemented, functions of the units may be implemented in one or more pieces of software and/or hardware.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a disk memory, a CD-ROM, an optical memory, and the like) that include computer-usable program code.

The present disclosure is described with reference to the flowcharts and/or block diagrams of the method, the device (system), and the computer program product according to the embodiments of the present disclosure. It will be understood that each flow and/or block in the flowcharts and/or block diagrams, and combinations of flows and/or blocks in the flowcharts and/or block diagrams, can be implemented by computer program instructions. These computer program instructions may be provided to a general-purpose computer, a special-purpose computer, an embedded processor, or a processor of another programmable data processing device to generate a machine, such that the instructions executed by the computer or the processor of another programmable data processing device generate an apparatus for implementing a function specified in one or more procedures in the flowcharts and/or one or more blocks in the block diagrams.

These computer program instructions may also be stored in a computer-readable memory that can guide a computer or another programmable data processing device to work in a specific manner, such that the instructions stored in the computer-readable memory generate a product including an instruction apparatus, and the instruction apparatus implements a function specified in one or more processes in the flowcharts and/or one or more blocks in the block diagrams.

These computer program instructions may also be loaded onto a computer or other programmable data processing device to cause a series of operational steps to be performed on the computer or other programmable device to produce computer-implemented processing, such that the instructions executed on the computer or other programmable device provide steps for implementing the functions specified in one or more flows of the flowcharts and/or one or more blocks of the block diagrams.

In a typical configuration, a computing device includes one or more processors (CPUs), an input/output interface, a network interface, and a memory.

The memory may include a volatile memory, a random-access memory (RAM), and/or a non-transitory memory in a computer-readable medium, for example, a read-only memory (ROM) or a flash RAM. Memory is an example of computer-readable media.

Computer readable media includes both permanent and non-permanent, removable and non-removable media capable of storing information by any method or technology. The information may be computer-readable instructions, data structures, modules of a program, or other data. Examples of computer storage media include, but are not limited to, a phase change random access memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission media, which can be used to store information that can be accessed by a computing device. As defined herein, the computer-readable medium does not include transitory media, such as modulated data signals and carrier waves.

It should also be noted that the terms “include”, “comprise” or any other variations thereof are intended to cover non-exclusive inclusion, such that a process, method, product or device including a series of elements includes not only those elements, but also other elements not explicitly listed, or elements inherent to such a process, method, product or device. An element proceeded by “comprises a . . . ” does not, without more constraints, preclude the existence of additional identical elements in the process, method, article, or device that includes the element.

A person skilled in the art should understand that the embodiments of the present disclosure may be provided as a method, a system, or a computer program product. Therefore, the present disclosure can use a form of hardware only embodiments, software only embodiments, or embodiments with a combination of software and hardware. Moreover, the present disclosure can use a form of a computer program product that is implemented on one or more computer-usable storage media (including but not limited to a disk memory, a CD-ROM, an optical memory, and the like) that include computer-usable program code.

The present disclosure can be described in the general context of computer-executable instructions executed by a computer, for example, a program module. Generally, program modules include routines, programs, objects, components, data structures, etc. that perform particular tasks or implement particular abstract data classifications. The present disclosure can also be practiced in distributed computing environments where tasks are performed by remote processing devices that are linked through a communications network. In a distributed computing environment, program modules may be located in both local and remote computer storage media including memory storage devices.

The embodiments in this disclosure are all described in a progressive manner, for same or similar parts in the embodiments, refer to each other, and each embodiment focuses on a difference from other embodiments. Especially, the system embodiments are basically similar to the method embodiments, and therefore are described briefly, and for related parts, refer to partial descriptions in the method embodiments.

The above descriptions are merely embodiments of the present disclosure, and are not intended to limit the present disclosure. For those skilled in the art, the present disclosure may have various modifications and variations. Any modification, equivalent replacement, or improvement made without departing from the spirit and principle of this disclosure shall fall within the scope of the claims of this application.

What is claimed is:

1. An asymmetric cross-modal large-model knowledge transfer method for remote sensing, comprising:
acquiring a training sample pair comprising a sample RGB image and a sample multi-spectral (MS) image, the sample RGB image and the sample MS image corresponding to a same scene classification;
inputting the sample MS image into a pre-trained teacher model, determining a first image feature extracted by the teacher model from the sample MS image, and determining a first scene classification, obtained by the teacher model according to the first image feature, as a pseudo label;
inputting the sample RGB image into a student model, determining a second image feature extracted by the student model from the sample RGB image, and determining a second scene classification obtained by the student model according to the second image feature; and
training the student model according to a difference between the second image feature and the first image feature and a difference between the second scene classification and the pseudo label.

2. The method according to claim 1, further comprising:
determining at least one positive sample pair and a plurality of negative sample pairs as a sample set, inputting the sample set into a to-be-trained matching model, and determining matching determination results for the sample set output by the to-be-trained matching model, wherein the positive sample pair comprises an RGB image and an MS image that share strong semantic consistency, and the negative sample pair comprises an RGB image and an MS image corresponding to different scene classifications;
training the to-be-trained matching model according to the matching determination results and actual matching situations between respective sample pairs in the sample set;
acquiring a to-be-matched RGB image set and a to-be-matched MS image set, wherein for any one RGB image in the to-be-matched RGB image set, the to-be-matched MS image set has an MS image with a same scene classification as the RGB image;
for any one RGB image in the to-be-matched RGB image set, in the to-be-matched MS image set, determining an MS image matching the RGB image as a target image by using a trained matching model, and matching the target image and the RGB image as a matched training sample pair; and combining multiple matched training sample pairs into a training sample set, and training the student model.

3. The method according to claim 1, wherein the pre-trained teacher model is obtained by:
acquiring a pre-training MS image;
inputting the pre-training MS image into a to-be-trained teacher model, and determining a third scene classification output by the to-be-trained teacher model; and
training the to-be-trained teacher model according to a difference between the third scene classification and a scene label of the pre-training MS image.

4. The method according to claim 1, wherein the first image feature and the second image feature have a same data structure;
training the student model according to the difference between the second image feature and the first image feature and the difference between the second scene classification and the pseudo label, comprises:
determining a first feature map corresponding to the first image feature and a second feature map corresponding to the second image feature according to a cross-modal attention;
determining the difference between the first image feature and the second image feature according to a domain shift loss between the first feature map and the second feature map; and
training the student model according to the difference between the second image feature and the first image feature and the difference between the second scene classification and the pseudo label.

5. The method according to claim 1, wherein training the student model according to the difference between the second image feature and the first image feature and the difference between the second scene classification and the pseudo label, comprises:
training the student model according to the difference between the second image feature and the first image feature, the difference between the second scene classification and the pseudo label, and a difference between the second scene classification and a real scene label corresponding to the sample RGB image.

6. The method according to claim 1, wherein acquiring the training sample pair comprising the sample RGB image and the sample MS image, comprises:
acquiring the training sample pair comprising the sample RGB image and the sample MS image from a training sample set, the training sample set comprising a plurality of training sample pairs;
after training the student model according to the difference between the second image feature and the first image feature and the difference between the second scene classification and the pseudo label, the method further comprises:
re-acquiring a training sample pair from the training sample set,
continuing to train the student model according to the re-acquired training sample pair until that a quantity of training times reaches a training threshold,
re-determining a second scene classification corresponding to each sample RGB image in the training sample set by using the student model that has been trained the quantity of training times,
updating sample MS images respectively matching each sample RGB image according to each redetermined second scene classification and a first scene classification corresponding to each sample MS image, and
continuing to train the student model according to updated training sample pairs.

7. The method according to claim 6, wherein updating the sample MS images respectively matching each sample RGB image according to each redetermined second scene classification and the first scene classification corresponding to each sample MS image comprises:
for any one sample RGB image in the training sample set, determining a sample MS image corresponding to a first scene classification with a smallest difference from the second scene classification of the sample RGB image, as a sample MS image matching the sample RGB image.

8. A non-transitory computer-readable storage medium, wherein the storage medium stores a computer program, and the computer program, when executed by one or more processors, implements operations comprising:
acquiring a training sample pair comprising a sample RGB image and a sample multi-spectral (MS) image, the sample RGB image and the sample MS image corresponding to a same scene classification;
inputting the sample MS image into a pre-trained teacher model, determining a first image feature extracted by the teacher model from the sample MS image, and determining a first scene classification, obtained by the teacher model according to the first image feature, as a pseudo label;
inputting the sample RGB image into a student model, determining a second image feature extracted by the student model from the sample RGB image, and determining a second scene classification obtained by the student model according to the second image feature; and
training the student model according to a difference between the second image feature and the first image feature and a difference between the second scene classification and the pseudo label.

9. The non-transitory computer-readable storage medium according to claim 8, wherein the computer program, when executed by the one or more processors, further implements operations comprising:
determining at least one positive sample pair and a plurality of negative sample pairs as a sample set, inputting the sample set into a to-be-trained matching model, and determining matching determination results for the sample set output by the to-be-trained matching model, wherein the positive sample pair comprises an RGB image and an MS image that share strong semantic consistency, and the negative sample pair comprises an RGB image and an MS image corresponding to different scene classifications;
training the to-be-trained matching model according to the matching determination results and actual matching situations between respective sample pairs in the sample set;
acquiring a to-be-matched RGB image set and a to-be-matched MS image set, wherein for any one RGB image in the to-be-matched RGB image set, the to-be-matched MS image set has an MS image with a same scene classification as the RGB image;
for any one RGB image in the to-be-matched RGB image set, in the to-be-matched MS image set, determining an MS image matching the RGB image as a target image by using a trained matching model, and matching the target image and the RGB image as a training sample pair; and
combining multiple matched training sample pairs into a training sample set, and training the student model.

10. The non-transitory computer-readable storage medium according to claim 8, wherein the pre-trained teacher model is obtained by:
acquiring a pre-training MS image;
inputting the pre-training MS image into a to-be-trained teacher model, and determining a third scene classification output by the to-be-trained teacher model; and
training the to-be-trained teacher model according to a difference between the third scene classification and a scene label of the pre-training MS image.

11. The non-transitory computer-readable storage medium according to claim 8, wherein the first image feature and the second image feature have a same data structure;
training the student model according to the difference between the second image feature and the first image feature and the difference between the second scene classification and the pseudo label, comprises:
determining a first feature map corresponding to the first image feature and a second feature map corresponding to the second image feature according to a cross-modal attention;
determining the difference between the first image feature and the second image feature according to a domain shift loss between the first feature map and the second feature map; and
training the student model according to the difference between the second image feature and the first image feature and the difference between the second scene classification and the pseudo label.

12. The non-transitory computer-readable storage medium according to claim 8, wherein training the student model according to the difference between the second image feature and the first image feature and the difference between the second scene classification and the pseudo label, comprises:
training the student model according to the difference between the second image feature and the first image feature, the difference between the second scene classification and the pseudo label, and a difference between the second scene classification and a real scene label corresponding to the sample RGB image.

13. The non-transitory computer-readable storage medium according to claim 8, wherein acquiring the training sample pair comprising the sample RGB image and the sample MS image comprises:
acquiring the training sample pair comprising the sample RGB image and the sample MS image from a training sample set, the training sample set comprising a plurality of training sample pairs;
after training the student model according to the difference between the second image feature and the first image feature and the difference between the second scene classification and the pseudo label, the operations further comprising:
re-acquiring a training sample pair from the training sample set,
continuing to train the student model according to the re-acquired training sample pair until that a quantity of training times reaches a training threshold,
re-determining a second scene classification corresponding to each sample RGB image in the training sample set by using the student model that has been trained the quantity of training times,
updating sample MS images respectively matching each sample RGB image according to each redetermined second scene classification and a first scene classification corresponding to each sample MS image, and
continuing to train the student model according to updated training sample pairs.

14. The non-transitory computer-readable storage medium according to claim 13, wherein updating the sample MS images respectively matching each sample RGB image according to each redetermined second scene classification and the first scene classification corresponding to each sample MS image comprises:
for any one sample RGB image in the training sample set, determining a sample MS image corresponding to a first scene classification with a smallest difference from the second scene classification of the sample RGB image, as a sample MS image matching the sample RGB image.

15. A device, comprising a memory, one or more processors, and a computer program stored in the memory and executable on the one or more processors, wherein when the one or more processors execute the program, the one or more processors are configured to implement operations comprising:
acquiring a training sample pair comprising a sample RGB image and a sample multi-spectral (MS) image, the sample RGB image and the sample MS image corresponding to a same scene classification;
inputting the sample MS image into a pre-trained teacher model, determining a first image feature extracted by the teacher model from the sample MS image, and determining a first scene classification, obtained by the teacher model according to the first image feature, as a pseudo label;
inputting the sample RGB image into a student model, determining a second image feature extracted by the student model from the sample RGB image, and determining a second scene classification obtained by the student model according to the second image feature; and
training the student model according to a difference between the second image feature and the first image feature and a difference between the second scene classification and the pseudo label.

16. The device according to claim 15, wherein the one or more processors are further configured to implement operations comprising:
determining at least one positive sample pair and a plurality of negative sample pairs as a sample set, inputting the sample set into a to-be-trained matching model, and determining matching determination results for the sample set output by the to-be-trained matching model, wherein the positive sample pair comprises an RGB image and an MS image that share strong semantic consistency, and the negative sample pair comprises an RGB image and an MS image corresponding to different scene classifications;
training the to-be-trained matching model according to the matching determination results and actual matching situations between respective sample pairs in the sample set;
acquiring a to-be-matched RGB image set and a to-be-matched MS image set, wherein for any one RGB image in the to-be-matched RGB image set, the to-be-matched MS image set has an MS image with a same scene classification as the RGB image;
for any one RGB image in the to-be-matched RGB image set, in the to-be-matched MS image set, determining an MS image matching the RGB image as a target image by using a trained matching model, and matching the target image and the RGB image as a training sample pair; and
combining multiple matched training sample pairs into a training sample set, and training the student model.

17. The device according to claim 15, wherein the pre-trained teacher model is obtained by:
acquiring a pre-training MS image;
inputting the pre-training MS image into a to-be-trained teacher model, and determining a third scene classification output by the to-be-trained teacher model; and
training the to-be-trained teacher model according to a difference between the third scene classification and a scene label of the pre-training MS image.

18. The device according to claim 15, wherein the first image feature and the second image feature have a same data structure;
training the student model according to the difference between the second image feature and the first image feature and the difference between the second scene classification and the pseudo label, comprises:
determining a first feature map corresponding to the first image feature and a second feature map corresponding to the second image feature according to a cross-modal attention;
determining the difference between the first image feature and the second image feature according to a domain shift loss between the first feature map and the second feature map; and
training the student model according to the difference between the second image feature and the first image feature and the difference between the second scene classification and the pseudo label.

19. The device according to claim 15, wherein training the student model according to the difference between the second image feature and the first image feature and the difference between the second scene classification and the pseudo label, comprises:
training the student model according to the difference between the second image feature and the first image feature, the difference between the second scene classification and the pseudo label, and a difference between the second scene classification and a real scene label corresponding to the sample RGB image.

20. The device according to claim 15, wherein acquiring the training sample pair comprising the sample RGB image and the sample MS image, comprises:
acquiring the training sample pair comprising the sample RGB image and the sample MS image from a training sample set, the training sample set comprising a plurality of training sample pairs;
after training the student model according to the difference between the second image feature and the first image feature and the difference between the second scene classification and the pseudo label, the operations further comprising:
re-acquiring a training sample pair from the training sample set,
continuing to train the student model according to the re-acquired training sample pair until that a quantity of training times reaches a training threshold,
re-determining a second scene classification corresponding to each sample RGB image in the training sample set by using the student model that has been trained the quantity of training times,
updating sample MS images respectively matching each sample RGB image according to each redetermined second scene classification and a first scene classification corresponding to each sample MS image, and
continuing to train the student model according to updated training sample pairs.
